(19) United States
(12) Patent Application Publication
(10) Pub. No.: US 2012/0279636 A1
(43) Pub. Date: Nov. 8, 2012

(54) FABRIC WINDING MACHINE

(75) Inventors: Frank Peters, Ankeny, IA (US); Benjamin Amborn Wollner, Ankeny, IA (US); Matthew Frank, Ames, IA (US)

(73) Assignee: IOWA STATE UNIVERSITY RESEARCH FOUNDATION, INC., Ames, IA (US)

(21) Appl. No.: 13/462,882

(22) Filed: May 3, 2012

Related U.S. Application Data
(60) Provisional application No. 61/481,781, filed on May 3, 2011.

(51) Int. Cl. B32B 38/18; B32B 37/10; B32B 37/02

(52) U.S. Cl. 156/184; 156/446

(57) ABSTRACT

An apparatus for fabric windings includes a rotating mandrel and a plurality of fabric supply rolls. The rotating mandrel pulls sheets of continuous fabric from the plurality of fabric supply rolls. The rotating mandrel includes a main body having an inner end and an outer end, the outer end having a diameter greater than a diameter of the inner end. The main body of the mandrel is generally cylindrical with two truncated surfaces opposite one another.

### CROSS-REFERENCE TO RELATED APPLICATIONS

This application claims priority under 35 U.S.C. §119 to provisional application Ser. No. 61/481,781 filed May 3, 2011, herein incorporated by reference in its entirety.

### FIELD OF THE INVENTION

The present invention relates to a fabric winding machine. More particularly, but not exclusively, the present invention relates to a fabric winding machine suitable for creating root preforms for wind turbine blades.

### BACKGROUND OF THE INVENTION

The background of the invention will be explained in the context of the problems associated with manufacturing wind turbine blades. It is, however, to be understood that the present invention is not limited to this specific application but may be used in any number of applications.

Wind is quickly emerging as the most viable renewable energy source. Thus, there is an ever-growing need for wind turbine installations. Wind turbine blades are necessary components of wind turbine installations. Manufacturing of wind turbines blades presents a number of problems. Many of these problems relate the fact that wind turbine blades are extremely large (there may be greater than 40 meters in length) and their manufacture is labor intensive and time-consuming.

One part of a wind turbine blade that is particularly problematic to manufacture is the root. The root of a wind blade is the thick base that attaches to a hub of the wind turbine. Depending upon the blade length and manufacturer, the root section of a blade can be in excess of 60 mm requiring many layers of fiberglass and a significant amount of labor to manufacture. Because of the amount of material, time, and labor that goes into this section of the blade, it is often prefabricated as a separate component offline and later infused into the blade.

In current processes to create the root performs, 100 or more plies of fabric may be used for each half of a mold. In a typical process, plies are lowered into a half cylinder of the mold and each layer is smoothed. As the layup sequence proceeds, each ply has a shorter length in order to form a taper. Such processes require multiple operators (3 or 4) to lay up in a mold. After layup, the part is infused such as through a Vacuum Assisted Resin Transfer Molding (VARTM) process and the resulting root is integrated into the blade halves.

Such processes are both time-consuming and labor intensive. What is needed are improved ways of manufacturing root preforms.

### SUMMARY OF THE INVENTION

Therefore, it is a primary object, feature, or advantage of the present invention to improve over the prior art.

It is further object, feature, or advantage of the present invention to provide a machine for use in manufacturing root preforms.

It is a further object, feature, or advantage to provide for manufacturing root preforms in a manner which significantly reduces labor.

Yet another object, feature, or advantage of the present invention is to provide for manufacturing root preforms in a manner which significantly reduces manufacturing time.

A still further object, feature, or advantage of the present invention is to provide for manufacturing root preforms in a manner which reduces the amount of materials used.

Another object, feature, or advantage is to provide for making a preform root as a single piece allow the full root to be bonded in a blade shell instead of splitting it and infusing a preform in each half.

Yet another object, feature, or advantage of the present invention is to provide a mandrel which allows the roots to be infused and cured offline so the machine can service multiple mandrels.

A still further object, feature, or advantage of the present invention is to provide a mandrel which may be collapsible.

Although various objects, features, and advantages are provided it is to be understood that no single embodiment of the invention need exhibit each or every object, feature, or advantage as different aspects or embodiments may provide for different advantages. Therefore, the invention is not to be limited to or by these objects, features, and advantages.

According to one aspect of the present invention an apparatus for fabric winding is provided. The apparatus includes a rotating mandrel and a plurality of fabric supply rolls. The rotating mandrel pulls sheets of continuous fabric for composites from the plurality of fabric supply rolls. The rotating mandrel includes a main body having an inner end and an outer end, the outer end having a diameter greater than a diameter of the inner end. The main body of the mandrel is generally cylindrical with two truncated surfaces opposite one another. The apparatus may further include a frame supporting a drive bar, the mandrel being mounted on the drive bar. The rotating mandrel may be sized and shaped for production of a root preform of a wind turbine blade. The rotating mandrel may be made to collapse to ease removal of the preform from the mandrel.

According to another aspect, a method of manufacturing a root preform for a wind turbine blade is provided. The method includes providing an apparatus for fabric winding, the apparatus including (a) a rotating mandrel, (b) a plurality of fabric supply rolls, and (c) wherein the rotating mandrel pulls sheets of continuous fabric from the plurality of fabric supply rolls. The method further includes operating the apparatus to produce a wound mandrel, removing the wound mandrel from the apparatus, placing the wound mandrel under vacuum and infusing the wound mandrel, and removing the root preform from the wound mandrel.

According to another aspect, an apparatus for fabric winding is provided. The apparatus includes a rotating mandrel and a plurality of fabric supply rolls containing sheets of continuous fabric for composites. The rotating mandrel pulls sheets of the continuous fabric for composites from the plurality of fabric supply rolls. The rotating mandrel comprises a main body having an inner end and an outer end, the outer end having a diameter greater than a diameter of the inner end and the main body being tapered from the outer end to the inner end. The main body of the rotating mandrel is generally cylindrical with two truncated surfaces opposite one another. The rotating mandrel is collapsible to facilitate removal of a preform from the rotating mandrel.

### BRIEF DESCRIPTION OF THE DRAWINGS

FIG. 1 illustrates an example of a wind turbine blade having a root preform.

FIG. 2 illustrates a fabric winding machine in operation at the layup start.

FIG. 3 illustrates a fabric winding machine in operation at the layup mid-roll.

FIG. 4A illustrates a mandrel used in the fabric winding machine and an insert

FIG. 4B illustrates a mandrel which is collapsible and which does not include an insert.

FIG. 5 illustrates another view of the fabric winding machine.

FIG. 6 illustrates an example of the fabric winding machine where tensioning sandwich rollers are used.

FIG. 7 illustrates forces on the tensioning sandwich rollers.

FIG. 8 illustrates one embodiment of a control system.

### DETAILED DESCRIPTION

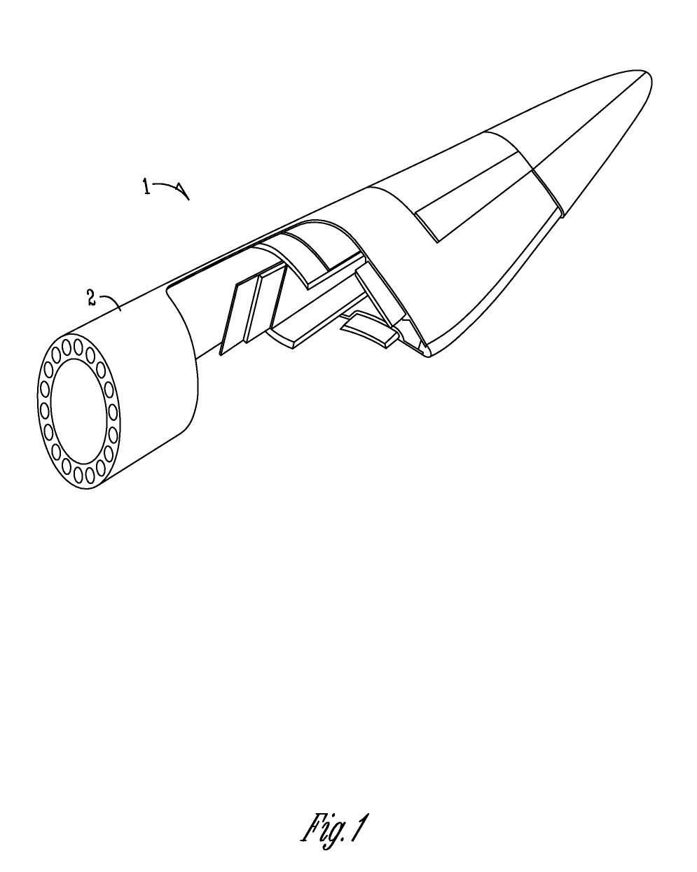

FIG. 1 illustrates an example of a wind turbine blade 1 having a root preform 2 made by the present invention. The root preform is made from composite materials such as high strength fiberglass reinforcement and a bonding polymer resin matrix to hold the preform shape and transfer load throughout the reinforcement material.

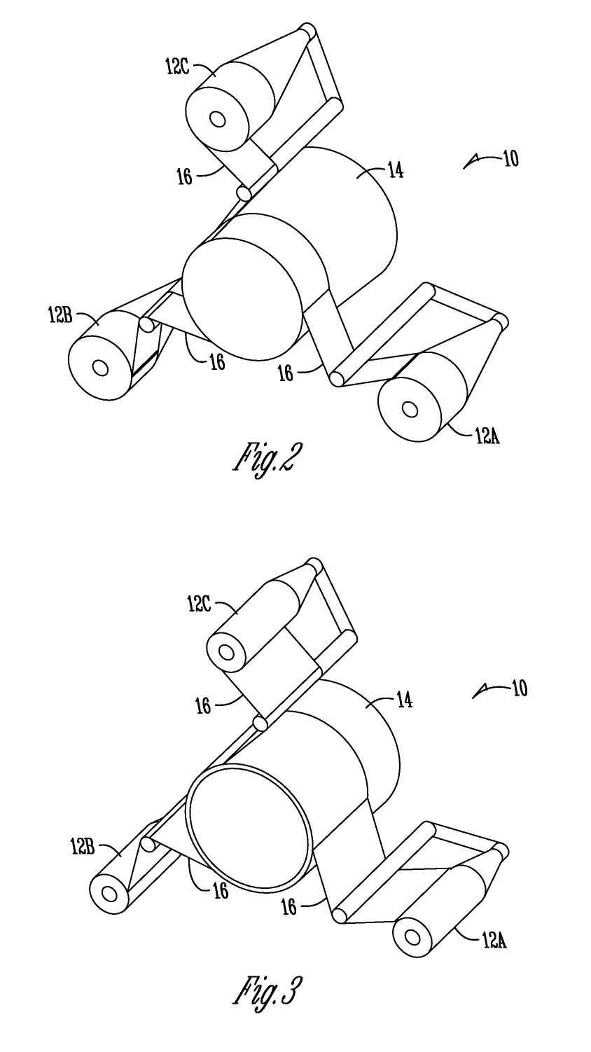

FIG. 2 illustrates a fabric winding machine 10 in operation at the layup start. Although three material roll feeders 12A, 12B, 12C are shown, other numbers may be used (preferably two or more). The material roll feeders supply the unidirectional (UD) and biaxial fabric simultaneously according to a ply schedule. As shown in FIG. 2, the material coming off of each roll will continuously widen as per the layup schedule. To improve utilization of the fabric it is intended that two pieces of increasing width may be matched, nested and cut from a full width roll; hence approaching 100 percent yield. The present invention contemplates that different types of composite fabrics may be used including multi-axial and Non Crimp Fabrics (NCF) for composites in glass and carbon fibers.

Although the panels are of tapering width, the geometry of the layup remains cylindrical from the first to last rotation. This is due to the fact that as the roll is unwound “up” the taper on the mandrel, the ply width increases proportionally. This enhances the ability to control parameters such as fabric placement and tension.

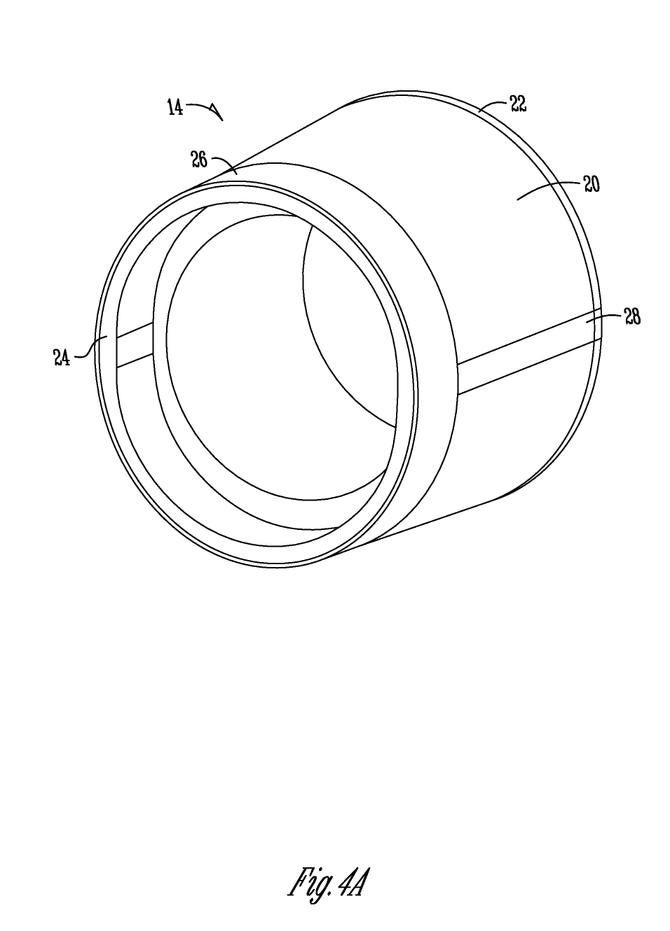

FIG. 3 illustrates the fabric winding machine 10 in operation at the layup mid-roll.

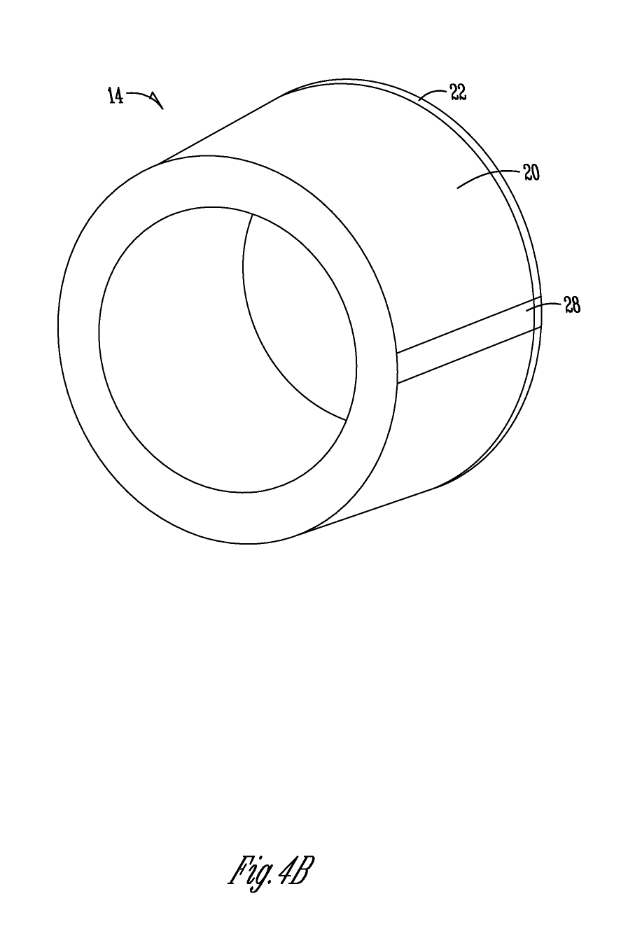

FIG. 4A illustrates one embodiment of the mandrel 14 in more detail. As shown, the mandrel 14 has a main body 20 with an outer end 22 having an outer diameter and an inner end 24 having an inner diameter. The outer diameter is greater than the inner diameter so that the mandrel is tapered. An insert 26 is shown which extends around the main body 20 proximate the inner end 24.

The insert 26 assists in getting a flat start for winding. The insert 26 is removable. The insert 26 may be made of any durable material capable of creating a mold surface that can be infused over and released from the final preform. The insert may have an airtight seal in order to hold a vacuum. When the preform is separated from the mandrel, the insert that is drafted on the inside only will come off with the preform. Once the preform is off the mandrel, the insert can be detached and reused. The insert need not be used as the present invention contemplates any number of other configurations which do not use the insert. For example, where the mandrel 14 shown is collapsible, this facilitates removal of the preform so that the insert is not necessary. FIG. 4B illustrates an embodiment with the mandrel 14 being collapsible and without an insert.

Note that the main body 20 of the mandrel 14 is not perfectly cylindrical in FIG. 4. Instead, the main body 20 is generally cylindrical with two truncated surfaces opposite one another. This shape is sometimes referred to as a race track shape, or a stadium shape. This flat section may be used to assist in operations such as cutting/handling as it provides sacrificial edges for the preform.

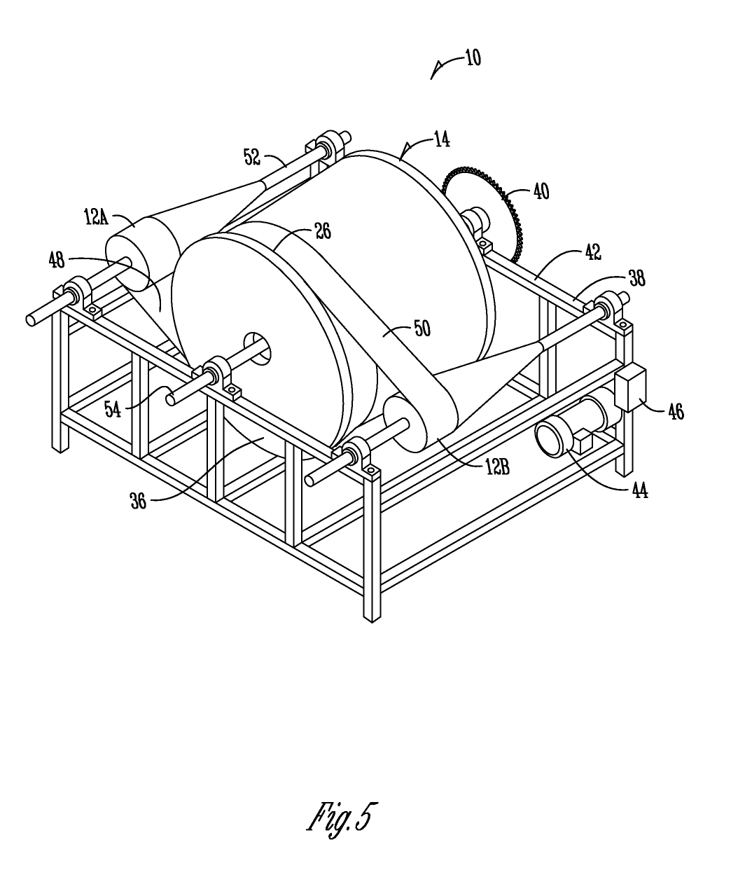

FIG. 5 illustrates the winding machine 10. The machine 10 has roll feeders 12A, 12B. Supply roll feeder 12A includes a supply bar 52 with a supply roll 48. Supply roll feeder 12B includes a supply bar 38 with a supply roll 50. The supply bars 38, 52 as well as the mandrel 14 are supported on a frame 42. A motor 44 is shown as well as a controller 46 operatively connected to the motor 44. The mandrel 14 is mounted on a drive bar 54 which is connected to a sprocket 40. A drive chain (not shown) may be used to connect a sprocket of the motor 44 with the sprocket 40. The mandrel 14 has an insert 26 and a cap 36.

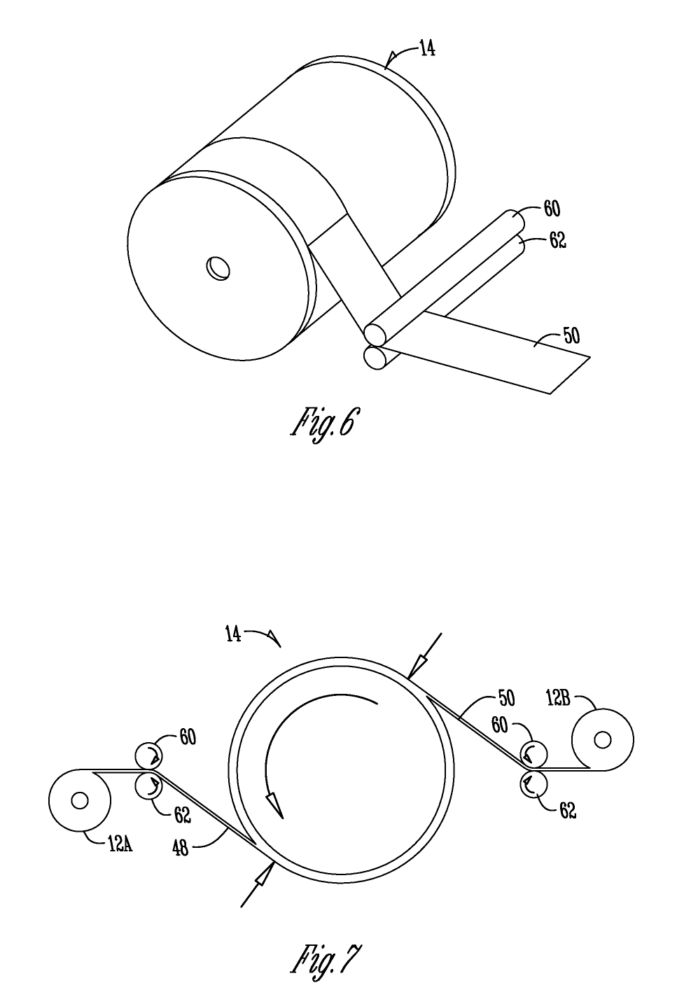

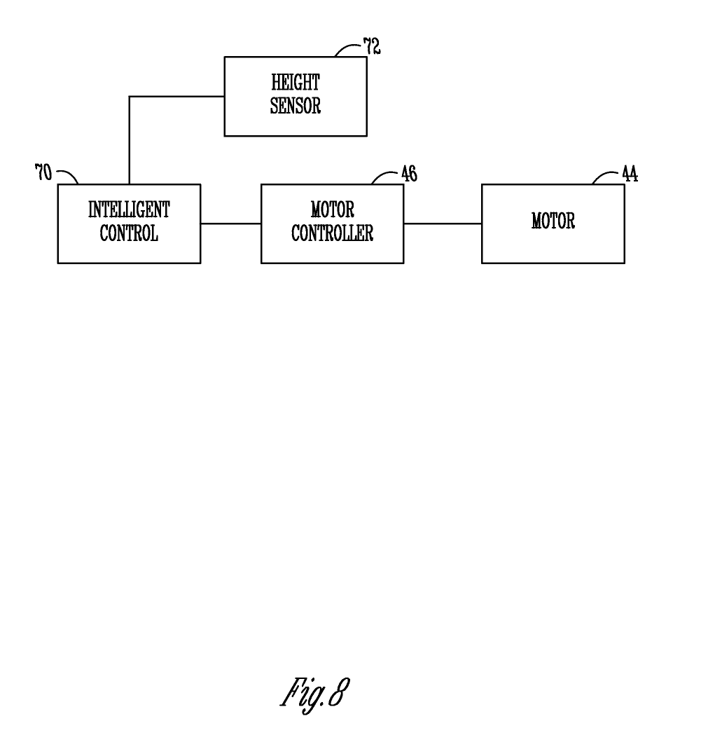

FIG. 6 illustrates one example of tensioning sandwich rollers 60, 62 which may be used. The sandwich rollers 60, 62 may be used for applying more controlled tension to the supply fabric 50. The sandwich rollers 60, 62 may be used apply the tension off of the supply roll but close to the mandrel 14. FIG. 7 illustrates forces on the tensioning sandwich rollers. Torque applied by the rollers 60, 62 acts against the torque from the rotating mandrel. This places tension on the fabric which compresses it against the mandrel. To eliminate waves in the preform, the compression created by the tensioning system should be equal to that of the compression caused by atmospheric pressure under vacuum. The amount of torque may be adjusted for different fabric types or to accommodate other variables.

FIG. 8 illustrates one example of a process control system which may be used. An intelligent control 70 is operatively connected to the motor controller 46 which is operatively connected to a motor 44. In addition, a height sensor 72 may be operatively connected to the intelligent control 70. The height sensor 72 may be used to stop the winding when a desired thickness is reached. The present invention further contemplates that additional sensors may be used to control the machine as may be appropriate in a particular implementation and depending upon the amount of automated control desired.

### Example

A prototype automation machine was designed and built for automation of a root preform. The prototype automation machine was used to create a manufactured scaled part. The machine was designed to create a wind blade root section at 50 percent scale of the current design for a 40 meter wind turbine blade, with a similar fabric pattern. Alternating fabric of axially oriented, unidirectional glass and biaxial glass were used to create the part. The prototype preform is 60 layers thick using only two continuous plies. The entire first part was successfully wrapped with minimal intervention in under 30 minutes. With practice and standard procedures, a full preform can likely be completed in 10 minutes. As a practical point, this would represent 5 minutes per root half; currently a several man-hour operation in the plant. The full scale root would take more time to wind, but not twice the time from the half scale to full scale as the process is mainly controlled by turning speed, hence the number of fabric layers, not the gross size of the fabric/part would be the rate limiting factor.

The wound mandrel was then removed from the machine, placed vertically, put under vacuum and infused. The final part was then cut down one side and slipped off the mandrel. An initial inspection showed the outer diameter to be within millimeters of the design 50 percent scale.

To prevent axial waves from forming after the vacuum is applied; various measures may be taken such as providing sufficiently tight and consistent tension on the feed rolls, the use of an outer mold, and/or vacuum bagging on the inner surface against a solid outer diameter.

To quantify the prototype quality, the three main features of the preforms, namely the outer diameter (OD), inner diameter (ID), and internal taper were measured with a FARO laser tracker. The first two preforms were measured only after the root was removed from the mandrel and cut apart, but the second root was also measured while it was still on the mandrel to check how the dimensions change without support from the mold. The preforms are also labeled A and B according to which half of the mandrel they were made on. Several hundred points were taken of each feature to compare them to a nominal shape and also measure the deviation from that shape. The OD and ID are measured as cylinders and the tapered section takes the shape of a cone. These values are presented in the below table.

| | | Trial 1 | | Trial 2 | |
|---|---|---|---|---|---|
| | | Preform A | Preform B | Preform A | Preform B |
| On | Diameter | — | — | 937.69 | 939.79 |
| Mandrel | Cylindricity | — | — | 3.55 | 3.48 |
| Off | OD | 929.02 | 946.91 | 923.84 | 942.12 |
| Mandrel | OD | 2.21 | 1.49 | 2.55 | 2.02 |
| | Cylindricity | | | | |
| | ID | 871.86 | 876.43 | 873.25 | 875.79 |
| | ID | 2.56 | 2.17 | 2.97 | 1.89 |
| | Cylindricity | | | | |
| | Taper | 6.32 | 6.35 | 6.58 | 6.47 |
| | Aperture | | | | |
| | (deg) | | | | |
| | Conical | 2.06 | 2.35 | 2.50 | 2.21 |
| | deviation | | | | |

The most critical value presented in this data set is the OD Cylindricity. The measurements found an average cylindricity of 2.06 mm over nearly a 1 meter diameter part, supporting the capabilities of the machine. Another value of interest is the discrepancy in OD measurements between side A and side B. Preforms 1A and 2A have similar OD values as do 1B and 2B, however there is an average 18 mm difference in OD between the two sides. These values evidence that the machine and methods described herein may be used to produce preforms of acceptable quality.

### Options, Variations, and Alternatives

Although particular embodiments have already been described, the present invention contemplates numerous options, and alternatives which may be appropriate or preferred in particular applications or uses. For example, the present invention contemplates that the mandrel may have embedded heating elements to aid and control curing of the infused preform. The present invention contemplates that other types of fabrics and layup schemes may be used. For example triaxial fabric (triax) which has fiber tows aligned in three orientations may be used. If a turbine blade manufacturer wanted to simplify a 1:1 (UD:Bias) lay further, the two supply rolls could be replaced with a single transverse triax (90 degrees, +45 degrees, −45 degrees) and achieve the same strength characteristics. Because the current preforms use a manual layup to create a very thick part, the plies used for the layup are often chosen more for deposition rates than for quality. The deposition rates of the winding machine may be sufficiently high enough that the marginal cost per layer may be almost negligible and thus thinner fabrics of higher quality may be used. These and other improvements may allow for a potential decrease in the preform thickness safety factor. The present invention further contemplates variations in changing ply schedule within a layup. The present invention further contemplates the use of a collapsible mandrel to ease its separation from the preform after infusion.

Thus, the present invention contemplates numerous variations in the specific materials used, the particular structures, and geometries of the mandrel, variations in the ply schedule, and other variations. Although described in the context of a root preform, the present invention contemplates use in other applications.

A fabric winding machine has been described. Although various details, options, variations, and alternatives have specifically been included herein, it is to be understood that the present invention may encompass other structures, features, not specifically described herein which may be appropriate or even preferred in particular applications.

What is claimed is:

1. An apparatus for fabric winding, comprising:
a rotating mandrel;
a plurality of fabric supply rolls containing sheets of continuous fabric for composites;
wherein the rotating mandrel pulls sheets of the continuous fabric for composites from the plurality of fabric supply rolls.

2. The apparatus of claim 1 wherein the rotating mandrel comprises a main body having an inner end and an outer end, the outer end having a diameter greater than a diameter of the inner end and the main body being tapered from the outer end to the inner end.

3. The apparatus of claim 2 wherein the main body of the mandrel is generally cylindrical with two truncated surfaces opposite one another.

4. The apparatus of claim 1 further comprising a frame supporting a drive bar, the mandrel being mounted on the drive bar.

5. The apparatus of claim 1 wherein the rotating mandrel is sized and shaped for production of a root preform of a wind turbine blade.

6. The apparatus of claim 5 wherein the wind turbine blade is 40 meters or greater in length.

7. The apparatus of claim 1 wherein the continuous fabric is continuous fiberglass fabric.

8. The apparatus of claim 1 wherein the rotating mandrel is collapsible.

9. A method of manufacturing a root preform for a wind turbine blade, the method comprising:
providing an apparatus for fabric winding, the apparatus comprising (a) a rotating mandrel, (b) a plurality of fabric supply rolls, and (c) wherein the rotating mandrel pulls sheets of continuous fabric from the plurality of fabric supply rolls;
operating the apparatus to produce a wound mandrel forming the root preform;
removing the wound mandrel from the apparatus;
placing the wound mandrel under vacuum and infusing the wound mandrel; and
removing the root preform from the wound mandrel.

10. The method of claim 9 wherein the continuous fabric is fiberglass fabric.

11. The method of claim 9 further comprising constructing a wind turbine blade using the root preform.

12. The method of claim 11 wherein the wind turbine blade is 40 meters or greater in length.

13. The method of claim 9 wherein the rotating mandrel of the apparatus comprises a main body having an inner end and an outer end, the outer end having a diameter greater than a diameter of the inner end and the main body being tapered from the outer end to the inner end.

14. The method of claim 13 wherein the main body of the mandrel is generally cylindrical with two truncated surfaces opposite one another.

15. The method of claim 14 wherein the apparatus further comprises a drive bar, the mandrel being mounted on the drive bar.

16. The method of claim 9 wherein the rotating mandrel is collapsible.

17. The method of claim 16 wherein the removing the root preform from the wound mandrel comprises collapsing the rotating mandrel.

18. An apparatus for fabric winding, comprising:
a rotating mandrel;
a plurality of fabric supply rolls containing sheets of continuous fabric for composites;
wherein the rotating mandrel pulls sheets of the continuous fabric for composites from the plurality of fabric supply rolls;
wherein the rotating mandrel comprises a main body having an inner end and an outer end, the outer end having a diameter greater than a diameter of the inner end and the main body being tapered from the outer end to the inner end;
wherein the main body of the rotating mandrel is generally cylindrical with two truncated surfaces opposite one another; and
wherein the rotating mandrel is collapsible to facilitate removal of a preform from the rotating mandrel.
